(19) United States
(12) Patent Application Publication
(10) Pub. No.: US 2008/0147212 A1
(43) Pub. Date: Jun. 19, 2008

(54) HOME APPLIANCE CONTROL DEVICE AND METHOD OF CONTROLLING HOME APPLIANCE

(75) Inventors: Nobuyuki MONMA, Osaka (JP); Morio Hirahara, Osaka (JP); Takayuki Yamamoto, Osaka (JP); Naohisa Oosaka, Osaka (JP); Shuichi Kyuma, Osaka (JP)

Correspondence Address: DLA PIPER US LLP, P. O. BOX 9271, RESTON, VA, 20195, US

(73) Assignees: KABUSHIKI KAISHA TOSHIBA, TOKYO (JP); TOSHIBA CONSUMER MARKETING CORPORATION, TOKYO (JP); TOSHIBA HA PRODUCTS CO., LTD, OSAKA (JP)

(21) Appl. No.: 11/954,026

(22) Filed: Dec. 11, 2007

(30) Foreign Application Priority Data
Dec. 14, 2006 (JP) 2006-337013

(51) Int. Cl. G06F 17/00

(52) U.S. Cl. 700/90

(57) ABSTRACT

A home appliance control device includes a terminal, a communication adapter, and a switch control unit. The switch control unit includes an allocating unit configured to recognize the number of the terminals, allocate specific identification numbers in accordance with a home appliance control protocol and store a correspondence relation between the identification numbers and terminal numbers, a storage unit configured to store a correspondence relation between the states of the terminals and property information in accordance with the home appliance control protocol, and carries out conversion between the identification numbers and the terminal numbers and conversion between the property information and state values of the terminal upon reception of a control command on the basis of the home appliance control protocol from the communication adapter.

### CROSS-REFERENCE TO RELATED APPLICATIONS

This application is based upon and claims the benefit of priority from the prior Japanese Patent Application No. 2006-337013, filed on Dec. 14, 2006; the entire contents of which are incorporated herein by reference.

### BACKGROUND

The present invention relates to a home appliance control device that switch-controls a contact point or the like, and a method of controlling the home appliance. More specifically, the invention relates to a device which has at least one terminal and controls home appliances connected to the individual terminals from an external communication network through a home appliance control protocol, and a method of controlling the home appliance.

Recently, development of a technology to connect home appliances such as air conditioners or room lamps to a controller via a home network and control operation of these home appliances from a personal computer or a cellular phone via an external internet, or a technology to inform the states of the home appliances to the outside became popular (for example, see WO2004/032425).

ECHONET is one of the network technologies described above. The ECHONET defines commands, objects and API for controlling facility-type appliances such as electric household appliances on physical media such as electric light wires or low power wirelesses, and establishes a home network by connecting the air conditioners, room lamps and refrigerators in a home by a network, so as to enable state monitoring or remote control of these appliances through remote operation using the cellular phone or the like.

There exist home appliances whose state of operation to be controlled and monitored is expressed by binary, that is, switch-controlled, such as appliances having an HA terminal (JEM-A). It is conceivable to remote-control a group of these appliances through an external communication network. In this case, since individual home appliances do not interpret a complex home appliance control protocol, it is not possible to control terminals to which the respective appliances are connected directly by the home appliance control protocol.

Therefore, it is necessary to provide the following mechanism in the interior of a home appliance control device to which the respective appliances are connected. The mechanism interprets the home appliance control protocol, converts signals on the basis of the protocol into control signals which is interpreted by the respective terminals, and transmits and receives these control signals to/from the terminals to achieve control. Also, it is preferable that the configuration of the home appliances connected to the respective terminals is automatically comprehensible.

### SUMMARY

In view of such circumstances, it is an object of the invention to improve convenience of users by the provision of a home appliance control device having home appliances to be switch-controlled connected thereto, in which an interface with respect to a home appliance control protocol is defined therein to enable the appliances connected to terminals to be controlled from an external communication network through the home appliance control protocol.

In order to achieve the object described above, a home appliance control device according to an embodiment of the invention includes at least one terminal to which a home appliance is connected and a communication adapter having a home appliance control protocol configured to communicate with an external communication network to switch-control the home appliance connected to the terminal, and further includes a switch control unit as shown below. The switch control unit includes a transmitter-receiver unit configured to transmit and receive control signals to/from the terminal, an allocating unit configured to recognize the number of the terminals, allocate specific identification numbers in accordance with the home appliance control protocol to terminal numbers of the respective terminals and store a correspondence relation between the identification numbers and the terminal numbers, a storage unit configured to store a correspondence relation between state values indicating the states of the terminals and property information in accordance with the home appliance control protocol and a communication unit configured to carry out data transmission in accordance with the home appliance control protocol with respect to the communication adaptor, and the switch control unit is configured to switch-control the terminals through conversion between the identification numbers and the terminal numbers and conversion between the property information and the state values of the terminals upon reception of a control command on the basis of the home appliance control protocol from the communication adapter.

A method of controlling home appliances according to an embodiment of the invention is configured to switch-control a home appliance connected to a terminal using a home appliance control device including at least one terminal to which the home appliance is connected and a communication adaptor having a home appliance control protocol configured to communicate with an external communication network. The method includes recognizing the number of the terminals, allocating specific identification numbers in accordance with the home appliance control protocol to terminal numbers of the respective terminals, storing a correspondence relation between the identification numbers and the terminal numbers, and storing a correspondence relation between state values indicating the states of the terminals and property information in accordance with the home appliance control protocol and, upon reception of a control command on the basis of the home appliance control protocol by the communication adapter from the external communication network, converting the identification member and the property information included in the control command respectively into the terminal number and the state value of the terminal on the basis of the correspondence relations and transmitting a control signal on the basis of the state value to the terminal having the terminal number obtained by the conversion.

According to the embodiment of the invention, since the identification numbers and the property information in accordance with the home appliance control protocol are transmitted after having converted into the control signals which are comprehended by the respective terminals upon reception of the control command on the basis of the home appliance control protocol from the external communication network, the home appliances connected to the terminals are controlled using the home appliance control protocol from the external communication network, and hence convenience of the user is improved.

### BRIEF DESCRIPTION OF THE DRAWINGS

FIG. 1 is a block diagram illustrating an example of a configuration of a home appliance control device according to an embodiment;

FIG. 2 is a block diagram illustrating an internal configuration of a contact point control unit of the home appliance control device;

FIG. 3 is an example of a correspondence table of object codes and terminal numbers;

FIG. 4 is an example of a property list;

FIG. 5 is a flowchart showing a sequence for activating the home appliance control device;

FIG. 6 is a flowchart showing a sequence to be carried out for a read command of the home appliance control device; and

FIG. 7 is a flowchart showing a sequence to be carried out for a write command of the home appliance control device.

### DETAILED DESCRIPTION

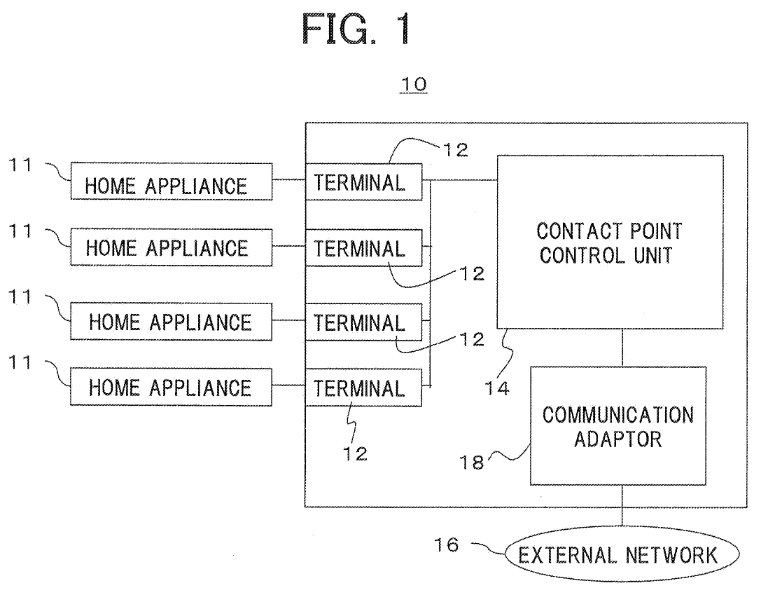

FIG. 1 is a block diagram illustrating an example of a configuration of a home appliance control device 10. As shown in the drawing, the home appliance control device 10 includes a plurality of terminals 12 to which home appliances 11 are connected, a contact point control unit 14 as a switch controller that switch-controls contact points and a communication adaptor 18 that is used for communicating with an external network 16. In this embodiment, an ECHONET protocol is used as a home appliance control protocol.

The terminals 12 are adapted to switch-control the contact points, for example, are HA terminals (JEM-A), and are capable of transmitting, receiving, or both of control signals that control the home appliances 11 connected to distal ends of the terminals 12. At least one terminal 12 is provided in the home appliance control device 10. The home appliances 11 to be connected to the terminals 12 are not limited as long as they are configured to be switch-controlled, and include air-conditioners, water heaters, lighting apparatuses and opening-closing devices for curtains or shutters.

The communication adaptor 18 interprets signals of the ECHONET protocol transmitted to and received from the external network 16, and gives instructions to the contact point control unit 14 correspondingly. The configuration of the communication adaptor 18 is described in ECHONET specifications Version 3.20 and Version 3.21, Part VII, Chapter 3 published by ECHONET CONSORTIUM, the entire contents of this specification being incorporated herein by reference, and those based on the specification may be used.

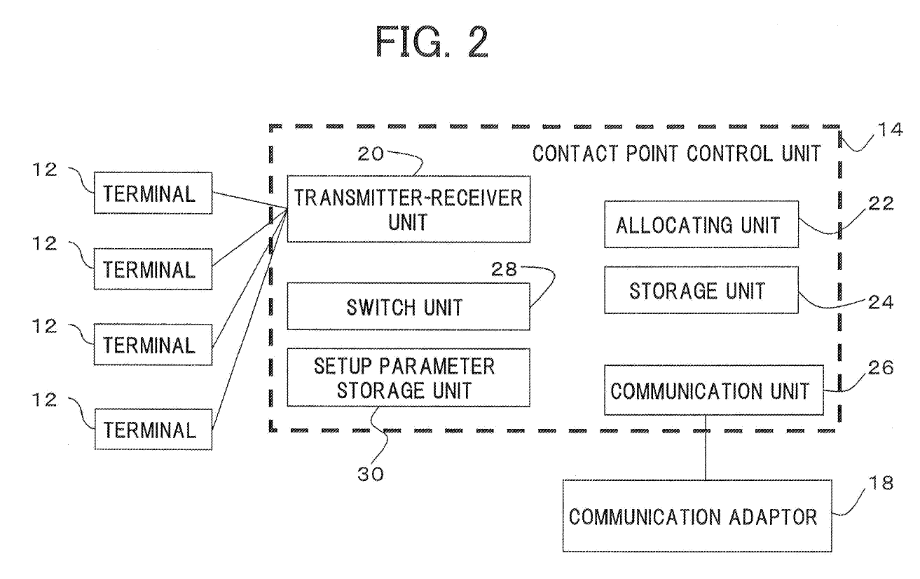

As shown in FIG. 2, the contact point control unit 14 includes a transmitter-receiver unit 20, an allocating unit 22, a storage unit 24 and a communication unit 26. In this example, it further includes a switch unit 28 and a setup parameter storage unit 30.

The transmitter-receiver unit 20 is a unit that transmits and receives control signals, which are interpreted by the terminals 12, to/from the terminals 12. This unit 20 is connected to the respective terminals 12 for giving instruction of transmitting or receiving the control signals to the terminals 12, as well as for receiving results of transmitting and receiving operation.

The allocating unit 22 is a unit that recognizes the number of terminals 12, and allocates specific identification numbers (that is, ECHONET object codes, referred to simply as “object codes” hereinafter) in accordance with the ECHONET protocol to terminal numbers of the respective terminals 12. This unit 22 also stores correspondence relation between the terminal numbers and the object codes. In this example, since the switch unit 28 and the setup parameter storage unit 30 are provided, setup parameter information stored in the switch unit 28 or the setup parameter storage unit 30 may be used for the allocation.

The storage unit 24 is a unit that stores default information used for controlling on the basis of the ECHONET protocol which is referred to as property in many cases. This unit 24 stores a property list which is a correspondence relation between state values indicating the state of the terminals 12 and property information in accordance with the ECHONET protocol.

The communication unit 26 is a communication interface with respect to the communication adaptor 18, and is a unit being connected to the communication adaptor 18 to carry out data transmission in accordance with the ECHONET protocol with respect to the communication adaptor 18.

The switch units 28 are provided for the respective terminals 12 to set information on the home appliances 11 connected to the respective terminals 12 from the outside using hardware and, in this example, are composed of a dip switch. The switch unit 28 is used for setting the information of home appliances 11 when they are newly connected to the terminals 12 in the home appliance control device 10, and is a unit that provides defaults to the terminals 12. Information to be set includes effectiveness/ineffectiveness of the terminals (that is, information indicating whether or not the connected home appliances are in a state of blocking communication control via the terminals), types of the home appliances, and places where the home appliances are installed.

The setup parameter storage unit 30 is a unit that stores setup parameter information on the home appliances 11 connected to the terminals 12. In this example, since the switch unit 28 is provided, the default information of the terminals 12 set by the switch unit 28 is read and stored. The setup parameter information provided by the ECHONET protocol through the external network may also be stored on the basis of instructions from the user. When the switch unit 28 is not provided, the default information may be provided to the setup parameter storage unit 30 by communication through the external network.

Operation for activating the home appliance control device 10 will be described.

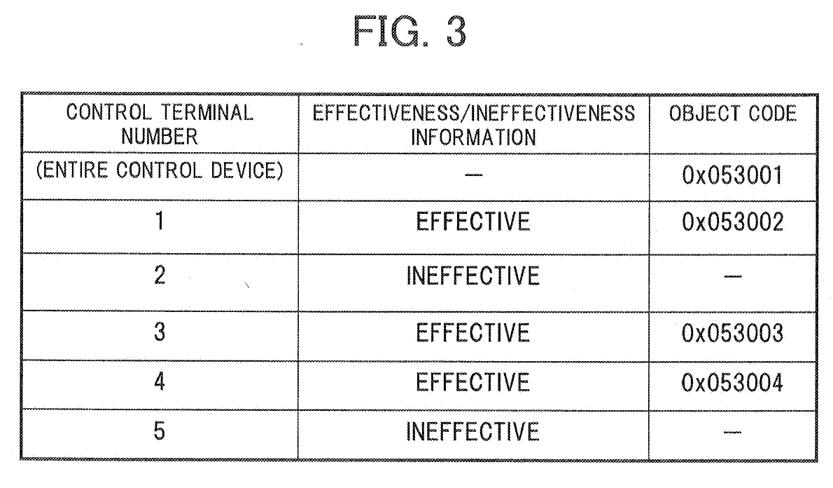

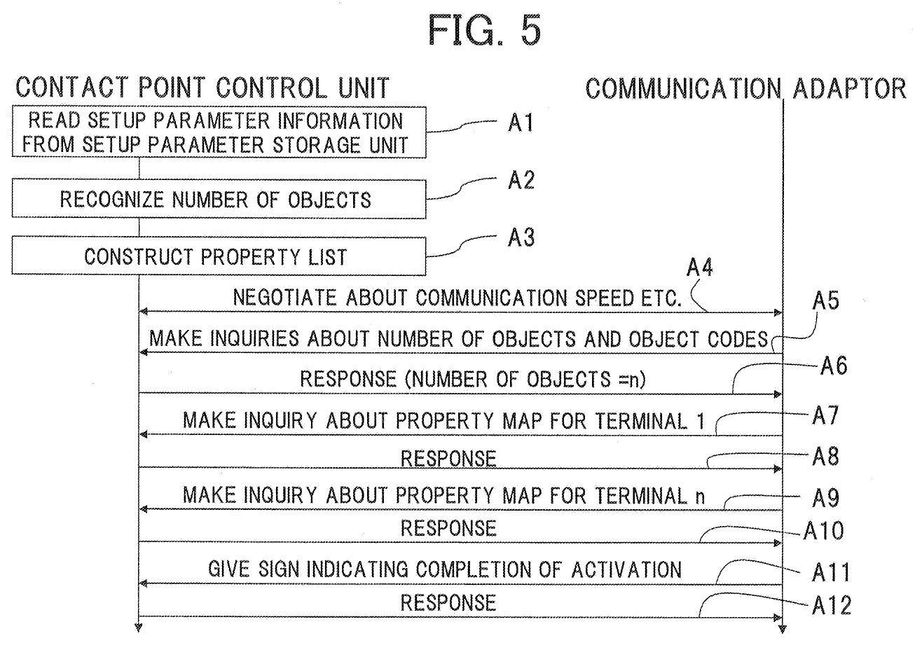

A sequence of activation is shown in FIG. 5. In a first step, the contact point control unit 14 reads setup parameter information including effectiveness/ineffectiveness of the terminals 12, and types or places of installation of the home appliances 11 from the setup parameter storage unit 30 (Step A1). The allocating unit 22 inspects the terminals 12 which are effective from among all the connected terminals 12 on the basis of the readout information to recognize the number of objects, that is, the number of effective terminals, allocates the object codes to the effective terminals automatically on the individual basis, and stores a correspondence table of the terminal numbers and the object codes as shown in FIG. 3 therein (Step A2).

When the switch unit 28 and the setup parameter storage unit 30 are not provided, the same operation as described above is carried out supposing that all the terminals 12 are effective.

A conceivable method of allocating the object codes is, as shown in FIG. 3, to allocate an object code “0x053001” to the entire home appliance control device 10, and object codes from “0x53002” onward to the individual terminals 12.

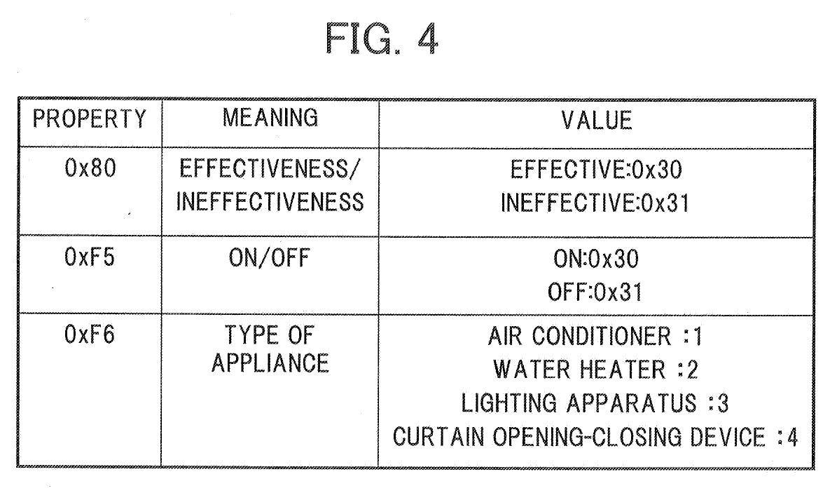

Subsequently, the contact point control unit 14 constructs a property list (Step A3). In the ECHONET, the appliances are controlled by reading and writing values to identifiers, which are referred to as “property”. Control of the respective terminals 12 between effectiveness and ineffectiveness or ON and OFF is achieved by reading and writing values to properties which represent these states. Therefore, properties are defined for the respective terminals, and the property list showing the correspondence relation between the states of the terminals 12 and the property information in accordance with the ECHONET protocol as shown in FIG. 4 is prepared and stored in the storage unit 24.

In the example shown in FIG. 4, for example, whether the terminal 12 is effective can be inspected by reading the value of a property “0x80”, and the home appliance 11 connected to the terminal 12 can be turned ON by writing a value “0x30” to a property “0xF5”.

At the time of activation, a property map as shown below is constructed by the contact point control unit 14 again.

Readout Property Map: 0x80, 0xF5, 0xF6

Writable Property Map: 0xF5

In other words, properties used only for knowing the states of the appliances (for example, effectiveness/ineffectiveness of terminals or types of appliances) are classified only to the readout property map, and properties used not only for knowing but also for changing the states of the appliances (for example, ON/OFF) are classified to the writable property map as well as the readout property map.

Subsequently, the communication unit 26 carries out negotiation with the communication adaptor 18 about the communication speed and so on (Step A4). The method of negotiation is not specifically limited, and may be selected as needed from known various methods.

Then, the communication adaptor 18 makes inquiries to the contact point control unit 14 about the number of objects and the object code (Step A5). The contact point control unit 14 returns the number of objects obtained by the allocating unit 22 at the time of recognition of the number of objects and the allocated object codes as a response to the communication adaptor 18 via the communication unit 26 (Step A6).

The communication adaptor 18 generates objects in the interior thereof as many as the number of objects obtained thereby, and sends inquiries to the contact point control unit 14 about the property maps for the respective objects (Step A7). The contact point control unit 14 returns the property maps constructed on the basis of the information stored in the storage unit 24 to the communication adaptor 18 as a response via the communication unit 26 (Step A8). These steps are repeated by the number of times which corresponds to the number of objects (Steps A9 and A10).

Finally, the communication adaptor 18 sends a cue which indicates completion of activation to the contact point control unit 14 (Step A11), and the communication unit 26 returns a response thereto (Step A12). Accordingly, the operation of activation is ended and initialization is completed.

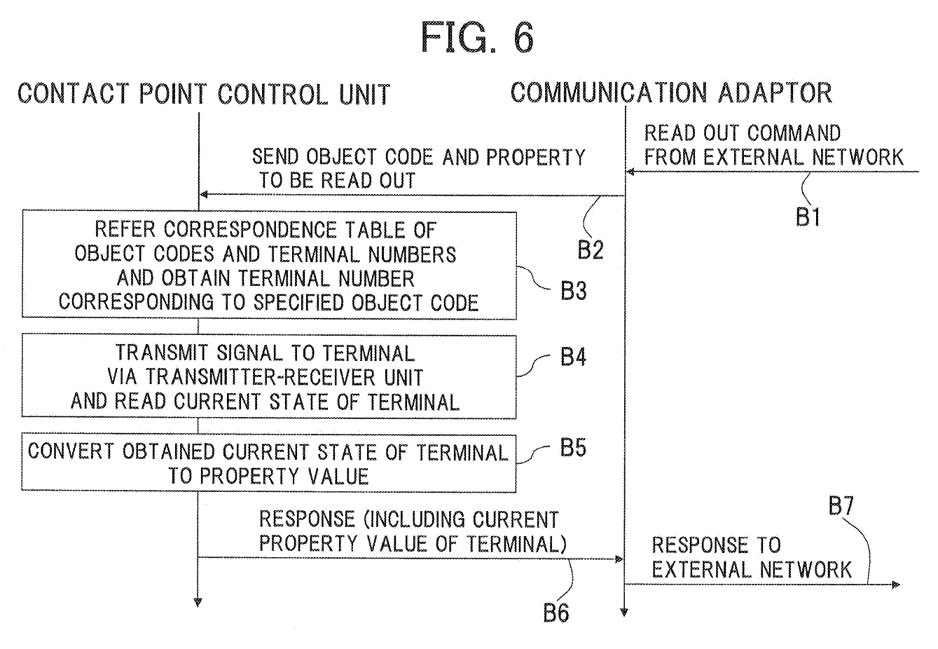

Referring now to FIG. 6, operation to be carried out when the home appliance control device 10 receives a readout command or the basis of the ECHONET protocol from the external network 16 by the communication adaptor 18 will be described.

When the state of the home appliance 11 connected to a certain terminal 12 is wanted to know from the external network 16, it is treated as the readout command in the ECHONET protocol. In this embodiment, operation is proceeded as shown below upon reception of such readout command.

The communication adaptor 18 receives a readout command signal from the external network 16 (Step B1). The signal includes an object code to be read out and property specified thereto. The communication adaptor 18 which has received the readout command transmits the object code and the property to be read out to the contact point control unit 14 (Step B2).

The contact point control unit 14 receives the signal through the communication unit 26, refers the correspondence table (see FIG. 3) of the object codes and the terminal numbers prepared when the allocating unit 22 carries out allocation for the individual terminals 12, and converts the specified object code into the corresponding terminal number (Step B3).

The contact point control unit 14 transmits a signal to the terminal 12 having the terminal number obtained in the procedure shown above via the transmitter-receiver unit 20, and reads out the current state of the terminal 12 (Step B4).

The contact point control unit 14 converts the current state of the terminal 12 obtained through transmitting and receiving of the signal shown above to a property value on the basis of the correspondence table in FIG. 4 prepared at the time of initialization (Step B5). For example, when the property to be read out is ON/OFF, if the state of the terminal 12 is ON, it is converted into “0x30”, and if OFF, it is converted into “0x31”.

The contact point control unit 14 returns a response including the property value as current information of the terminals 12 to the communication adaptor 18 via the communication unit 26 (Step B6). Then, the communication adaptor 18 receives the response, and sends it to the external network 16 which has issued the command as a read result (Step B7). Accordingly, the operation to be carried out upon reception of the readout command is ended.

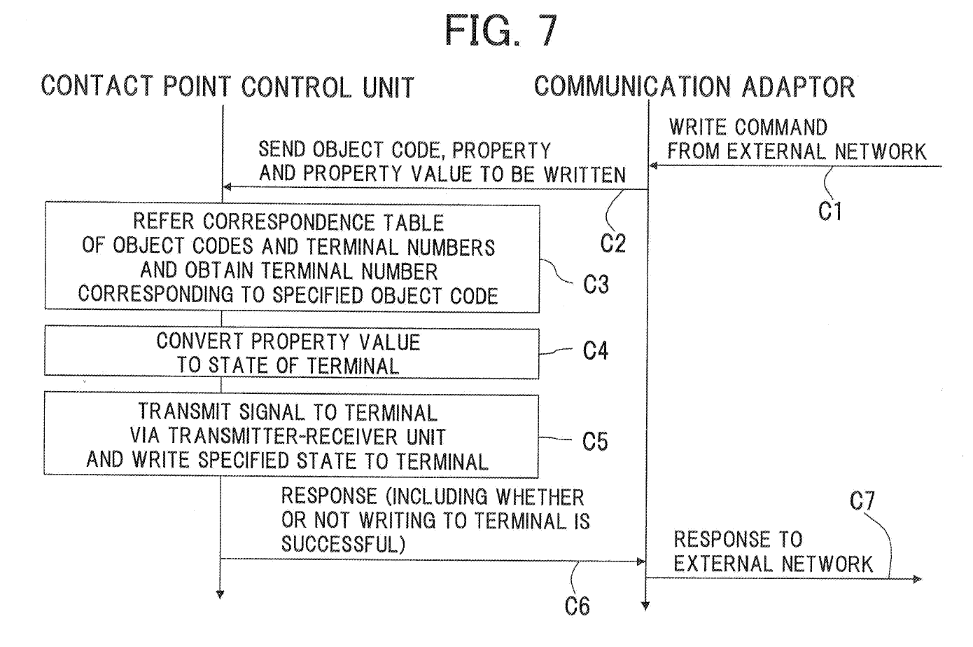

Referring now to FIG. 7, operation to be carried out when the home appliance control device 10 receives a write command on the basis of the ECHONET protocol from the external network 16 by the communication adaptor 18 will be described.

When changing the state of a home appliance 11 which is connected to a certain terminal 12 from the external network 16, it is treated as the write command according to the ECHONET protocol. In this embodiment, operation in the following procedure is carried out for such a control command.

The communication adaptor 13 receives a write command signal from the external network 16 (Step C1). The signal includes an object code, a property and a property value to be written specified thereto. Then, the communication adaptor 18 having received these values transmits the object code, the property and the property value to be controlled to the contact point control unit 14 (Step C2).

The contact point control unit 14 receives the signal via the communication unit 26, refers the correspondence table (see FIG. 3)) of the object codes and the terminal numbers prepared when the allocating unit 22 carries out allocation for the individual terminals 12, and converts the specified object code into the corresponding terminal number (Step C3).

The contact point control unit 14 converts the specified property value to a state value of the terminal 12 on the basis of the correspondence table in FIG. 4, which is prepared at the time of initialization (Step C4). For example, when the property means ON/OFF, if property value is “0x30”, the contact point control unit 14 converts it to a control signal which corresponds to ON state, and if the property value is “0x31”, the contact point control unit 14 converts it to a control signal which corresponds to OFF state.

The contact point control unit 14 then transmits the control signal converted in the procedure shown above to the terminal 12 having the terminal number obtained in the procedure shown above via the transmitter-receiver unit 20, and writes the specified state (Step C5).

Then, the contact point control unit 14 returns a response including information whether writing to the terminal 12 was successful or failed to the communication adaptor 18 via the communication unit 26 (Step C6). Then, the communication adaptor 18 receives the response, and sends it to the external network 16 having issued the command as a write result (Step C7). Accordingly, the operation to be carried out for the write command is ended.

As described above, according to the embodiment, the object codes on the basis of the ECHONET protocol allocated uniquely to the individual terminals 12 and the terminal numbers are converted with respect to each other, and the property information on the basis of the ECHONET protocol and the state values of the terminals are converted with respect to each other for the control command on the basis of the ECHONET protocol from the communication adaptor 18. Therefore, even the home appliances 11 which cannot interpret the ECHONET protocol appear to be as ECHONET appliances from the external network 16, so that they can be switch-controlled.

Also, the object code on the basis of the ECHONET protocol is converted into the terminal number, and the signal is sent to the terminal 12 specified thereby to read the current state of the terminal 12, and the state value of the read terminal 12 is converted into property information on the basis of the ECHONET protocol and is sent to the external network 16 for the readout command on the basis of the ECHONET protocol. Therefore, configurations of the home appliances 11 connected to the respective terminals 12 can be known easily even though the home appliances 11 cannot understand the ECHONET protocol.

In addition, since the switch unit 28 is provided, the default information can be provided for the individual terminals 12, so that discrimination of the appliances is clarified when the user controls the home appliances 11 connected to the terminals 12 by using the default information, thereby preventing erroneous operation.

Also, by providing the default information to the setup parameter storage unit 30 in advance, discrimination of the appliances is clarified when the user controls the home appliances 11 connected to the terminals 12 by using the default information, thereby preventing erroneous operation. In addition, the setup parameter information provided on the basis of the ECHONET protocol from the external network 16 by the user's instruction can be stored in the setup parameter storage unit 30. Therefore, the setup parameters can be stored even when the switch unit 28 is switched, and hence maintenanceability is improved.

Furthermore, when the allocating unit 22 recognizes the number of the terminals 12 and allocates the specific object codes to the individual terminals 12, a mechanism which does not allocate object codes to ineffective terminals 12, or allocates a particular object code including information indicating the type of the appliance when the type of the appliance is set may be employed by the use of the setup parameter information stored in the setup parameter storage unit 30. Therefore, erroneous operation when the user controls the home appliances 11 connected to the terminals 12 may be prevented.

In this embodiment, since the ECHONET protocol, which is a common home appliance control protocol, is employed as the home appliance control protocol, the control device can be operated on the basis of the same protocol as other general home appliances, so that convenience of the user is improved.

The invention is not limited to the embodiment shown above, and various modifications may be made without departing the scope of the invention.

What is claimed is:

1. A home appliance control device having at least one terminal to which a home appliance is connected and a communication adapter having a home appliance control protocol configured to communicate with an external communication network to switch-control the home appliance connected to the terminal, comprising a switch control unit, the switch control unit including:
a transmitter-receiver unit configured to transmit and receive control signals to/from the terminal;
an allocating unit configured to recognize the number of the terminals, allocate specific identification numbers in accordance with the home appliance control protocol to terminal numbers of the respective terminals and store a correspondence relation between the identification numbers and the terminal numbers;
a storage unit configured to store a correspondence relation between state values indicating the states of the terminals and property information in accordance with the home appliance control protocol; and
a communication unit configured to carry out data transmission in accordance with the home appliance protocol with respect to the communication adaptor,
wherein the terminals are switch-controlled by carrying out conversion between the identification numbers and the terminal numbers and conversion between the property information and the state values of the terminals upon reception of a control command on the basis of the home appliance control protocol from the communication adapter.

2. The home appliance control device according to claim 1, comprising a switch unit configured to provide a defaults for the terminals including information such as whether or not the home appliances connected to the terminals are effective, types and places of installation of the home appliances

3. The home appliance control device according to claim 1, comprising a setup parameter storage unit configured to store setup parameter information of the terminals.

4. The home appliance control device according to claim 2, comprising a setup parameter storage unit configured to store setup parameter information of the terminals.

5. The home appliance control device according to claim 1, wherein the allocating unit recognizes the number of effective terminals on the basis of the states of the terminals, and allocates the specific identification numbers respectively to the effective terminals.

6. The home appliance control device according to claim 2, wherein the allocating unit recognizes the number of effective terminals on the basis of states of the terminals or the defaults provided by the switch unit, and allocates the specific identification numbers respectively to the effective terminals.

7. The home appliance control device according to claim 4, wherein the allocating unit recognizes the number of effective terminals on the basis of the states of the terminals, the defaults provided by the switch unit, or the setup parameter information stored in the setup parameter storage unit and allocates the specific identification numbers respectively to the effective terminals.

8. The home appliance control device according to claim 1, wherein the home appliance control protocol is an ECHONET protocol.

9. A method of controlling home appliances for switch-controlling home appliances connected to terminals using a home appliance control device including at least one terminal to which the home appliance is connected and a communication adaptor having a home appliance control protocol configured to communicate with an external communication network, comprising:
recognizing the number of the terminals;
allocating specific identification numbers in accordance with the home appliance control protocol to terminal numbers of the respective terminals;
storing a correspondence relation between the identification numbers and the terminal numbers;
storing a correspondence relation between state values indicating states of the terminals and property information in accordance with the home appliance control protocol;
converting the identification numbers and the property information included in a control command respectively into the terminal numbers and the state values of the terminals on the basis of the correspondence relations upon reception of the control command on the basis of the home appliance control protocol by the communication adapter from an external communication network; and
transmitting a control signal on the basis of the state value to a terminal having the terminal number obtained by the conversion.

10. The method of controlling hone appliances according to claim 9, comprising:
converting the identification number included in a readout command to the terminal number on the basis of the correspondence relation upon reception of the readout command on the basis of the home appliance control protocol from the external communication network;
transmitting the signal to the terminal having the terminal number obtained by the conversion to readout a current state value of the terminal;
converting the read state value of the terminal into the property information on the basis of the correspondence relation; and
transmitting a response including the property information to the external communication network via the communication adaptor.

11. The method of controlling home appliances according to claim 9, wherein the home appliance control protocol is an ECHONET protocol.
